(19) United States
(12) Patent Application Publication
(10) Pub. No.: US 2006/0013727 A1
(43) Pub. Date: Jan. 19, 2006

(54) Reagent carrier

(75) Inventor: Peter Rudloff, Ladenburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: scil animal care company GmbH, Viernheim (DE)

(21) Appl. No.: 11/183,389

(22) Filed: Jul. 18, 2005

(30) Foreign Application Priority Data
Jul. 19, 2004 (DE) 10 2004 034 801.4

(51) Int. Cl. G01N 21/00

(52) U.S. Cl. 422/58

(57) ABSTRACT

A reagent carrier has a first chamber, which contains a reagent. The reagent carrier is characterized in that at least one second chamber is provided to hold blood, a third chamber is provided to hold a dye and a fourth chamber is designed as a measurement chamber.

The present invention relates to a reagent carrier having a first chamber which contains a reagent. Priority is claimed to German Patent Application Serial No. DE 10 2004 034 801.4, filed Jul. 19, 2004, the entire disclosure of which is hereby incorporated by reference herein.

### BACKGROUND

Counting and differentiating cells in body fluids are regularly used in human and veterinary medicine for diagnosing diseases and for checking on the health of a patient. To permit a simple determination of these parameters, partially or fully automatic analyzers have been developed for performing the required tests easily. As a rule, different reagents, depending on the desired test, may be used for the determination of cell counts and the proportions of various populations. For example, different dyes are used to stain the various constituents of blood cells. Anticoagulants prevent coagulation of blood, which would interfere with performing the measurement. Reagents are also needed for hemolysis to break up erythrocytes.

The problem of supplying the required reagents in a simple manner occurs with analyzers at smaller laboratories, such as those found in a doctor's or veterinarian's office. Another factor to be taken into account is that the properties of the reagents may change on coming in contact with oxygen and due to the effects of temperature during storage, so the accuracy of the measurement result may be influenced.

### SUMMARY OF THE INVENTION

An object of the present invention is to provide a reagent carrier which is particularly simple to handle.

The present invention provides a reagent carrier (1), having a first chamber (2) containing a reagent, wherein at least one second chamber (3) is provided to hold a body fluid, in particular blood, a third chamber (4) is provided to hold a dye and a fourth chamber (5) is designed as a measurement chamber.

The reagents and/or dyes required in each case may be supplied to the analyzer with the reagent carrier. The reagent carrier is simply inserted into a holder provided in the analyzer before the start of the measurement. Since the reagent carrier also includes a chamber to hold blood, a blood sample may be placed in the reagent carrier and inserted into the analyzer together with the desired reagents, thereby further simplifying handling. The reagent carrier according to the present invention is intended for a single use.

The reagent advantageously induces hemolysis.

According to an advantageous embodiment of the present invention, the dye is excited to fluorescence by red light and has an absorbance maximum in the range between 610 nm and 650 nm, in particular in the range between 620 nm and 640 nm. Such a dye, in particular blue dye, may be used for staining various cell constituents. Use of the dye described here permits the use of a red laser, which is cost-effective.

It has proven successful here if the dye is oxazine-1 perchlorate.

According to an advantageous refinement of the present invention, the dye is in a solution which contains in particular a buffer for regulating the pH.

The reagent carrier advantageously has a machine-readable code, in particular in the form of a barcode. The code may contain information about the reagent and/or dye contained in the reagent carrier and/or size parameters of the measurement chamber. It is possible in this way to transmit information about the reagent carrier used and/or its ingredient to the analyzer and thereby improve the analytical result. The particular information may then be used as part of this measurement to correct the measured values. It is particularly advantageous to store information about the thickness of the measurement chamber in the code; in the embodiment using glass plates, the thickness corresponds to the distance between the glass plates and may differ from one reagent carrier to the next.

The handling of the reagent carrier is simplified if the first, third and fourth chambers are sealed with a first cover film. This protects the reagent and/or the dye from environmental influences.

A further improvement is achieved by covering the second chamber with a second cover film. This provides a separate seal for the chamber for blood and this chamber may be opened independently of the other chambers to add a small quantity of blood or some other body fluid.

Handling is further simplified in that the second film has a grip section with which the second film may be pulled away from the reagent carrier. This design makes it possible to pull away the second film in particular without any further aid and to open the chamber for blood.

Manufacturing is facilitated by the fact that the reagent carrier is made of plastic, so that the first and/or second cover film is welded to the reagent carrier.

If the volume of the second chamber is smaller than the volume of the first chamber, the reagent carrier is particularly suitable for analyzing small quantities of blood such as those frequently encountered in veterinary medicine.

According to a refinement of the present invention, the first, second and/or third chambers have inclined side walls tapering to a point in at least some sections. This permits, among other things, measurement with particularly small quantities of blood.

It has proven advantageous if the volume of the second chamber is between 50 and 150 microliters and the volume of the first, third and fourth chambers each is between 250 and 350 microliters.

Thorough mixing using the back-and-forth movement of the reagent carrier is improved by providing protrusions or webs in the second and/or third chamber.

According to the present invention, the second chamber may contain an anticoagulant.

The anticoagulant is advantageously in the form of a lyophilizate. A lyophilizate is a substance manufactured by lyophilization (freeze drying). If webs and/or protrusions are designed in the second chamber at the same time, the voluminous structure of the lyophilizate may be supported during transport and storage and preserved better.

Particularly good measurement results may be obtained with the reagent carrier if the measurement chamber is provided with a glass plate on at least one side, in particular on two opposing sides. Glass plates have little effect on the measurement results due to their good optical properties and furthermore they are inexpensive to manufacture.

The glass plates, in particular planar plates, may be used in receptacles provided on the reagent carrier.

A further improvement is achieved by the fact that the receptacles have lips which hold the glass plates in position and/or seal them.

The reagent carrier is particularly inexpensive to manufacture because the reagent carrier has a plastic body into which the glass plates are inserted, and a wall of the plastic body has a recess in the area of each glass plate. The recess permits optical access through the glass plates to the interior of the measurement chamber.

The recess is preferably covered by the glass plates situated next to the recess, in which case the receptacle for the glass plates may be situated on the inside of the wall of the measurement chamber.

Since the reagent carrier has four side faces, at least one of which has a shape different from that of the opposing side face, this prevents twisting, i.e., incorrect insertion into the analyzer.

It has proven successful if one of the side faces has a convex form and/or the opposing side face has a concave form.

The present invention also relates to a use of a reagent carrier described in the present patent application in a device for determining the parameters of blood, which is introduced into the second chamber before the start of the measurement.

### BRIEF DESCRIPTION OF THE DRAWINGS

Additional goals, features, advantages and possible applications of the present invention are derived from the following description of exemplary embodiments on the basis of the drawings, in which:

FIG. 1 shows a top view of a reagent carrier according to the present invention;

FIG. 2 shows a cross section through the reagent carrier in FIG. 1 along line A-A; and

FIG. 3 shows a side view of the reagent carrier from FIG. 1.

All the features described here and/or illustrated in the figures may constitute the object of the present invention either alone or in any combination, also independently of how they are combined in individual claims and/or their reference back to other claims.

### DETAILED DESCRIPTION

The figures show a reagent carrier 1 having a first chamber 2, a second chamber 3, a third chamber 4 and a fourth chamber 5. Reagent carrier 1 may be inserted into an analyzer (not shown here).

Reagent carrier 1 has a plastic body 6 which may be manufactured from Hostalen, for example.

First chamber 2 in the exemplary embodiment depicted here has an essentially rectangular base area having smooth side walls 7. The volume of the first chamber is between 250 and 350 microliters.

A reagent (not shown) is accommodated in first chamber 2. According to the present invention, a substance which induces hemolysis is preferably added to first chamber 2. This makes it possible to break up erythrocytes.

Second chamber 3 is used to accommodate a small blood sample on the basis of which the analysis is performed. Second chamber 3 has an essentially circular basic shape and has inclined side walls 8 in a lower section. The volume of second chamber 3 is smaller than the volume of first, third and fourth chambers 2, 4, 5 and is between 50 and 150 microliters. Second chamber 3 has a plurality of webs and/or protrusions 9, extending downward on side walls 8 and converging in the middle at the lower end of second chamber 3, as shown clearly in FIG. 2. In the left half of second chamber 3, as shown in FIG. 2, the cross section passes through a web 9, but in the right half of FIG. 2, it passes through the area set back between two webs 9. At the upper end of second chamber 3, a chamfer which drops toward the inside and facilitates the filling of the second chamber by a pipette or the like is provided.

An anticoagulant (not shown) is contained in second chamber 3. This reduces and/or prevents the coagulation of blood. The anticoagulant here is in the form of a lyophilizate, which is a substance produced by lyophilization (e.g., freeze-drying). This substance is able to fulfill its function particularly well because second chamber 3 contains webs and/or protrusions 9 that support and preserve the voluminous structure of the lyophilizate even in prolonged storage.

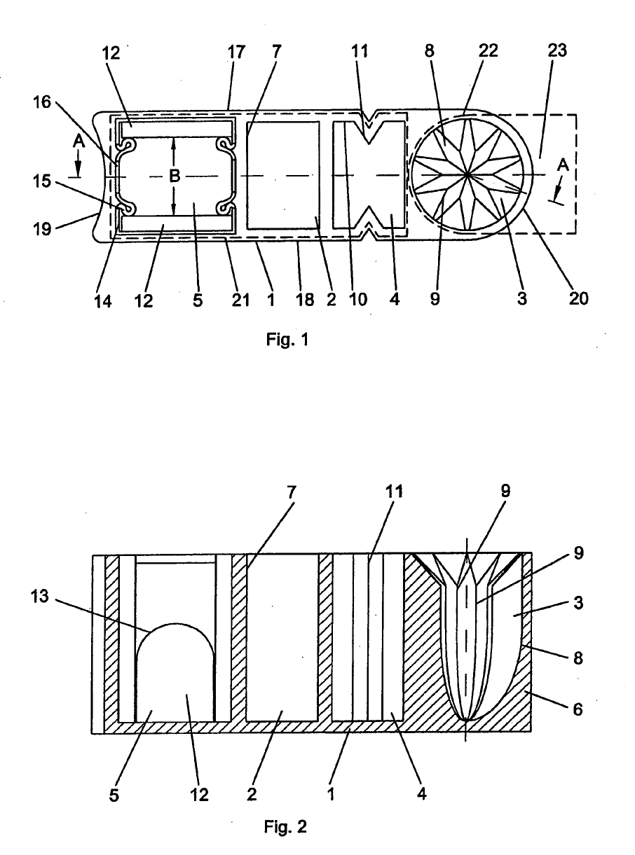

Third chamber 4 having an essentially rectangular basic shape has protrusions 11 on two opposing side walls 10, protruding from side wall 10 into third chamber 4. When observed from above, as shown in FIG. 1, protrusions 11 have a triangular shape and extend over the entire height of third chamber 4.

A dye (not shown) is accommodated in third chamber 4. The dye is suitable for staining blood cells and/or the constituents thereof. A fluorescent blue dye is used in particular as the dye, preferably a dye excitable by red light and having a maximum absorbance in the range between 610 nm and 650 nm (or even better, 620 nm to 640 nm). Commercially available oxazine-1 perchlorate has proven to be such a dye.

The dye is present in a solution which contains in particular a buffer for regulating the pH in a range of pH 6 to pH 8, preferably pH 7.2 to pH 7.6.

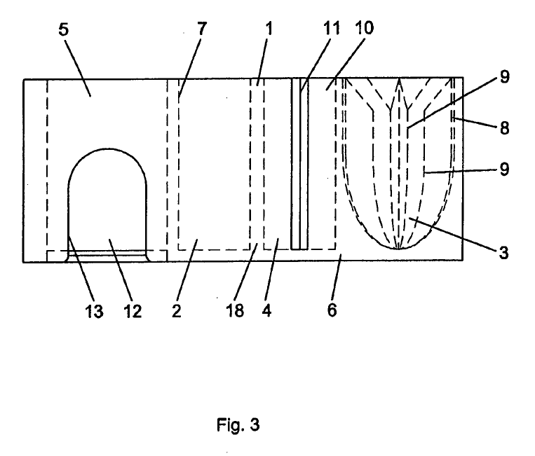

Fourth chamber 5 is designed as a measurement chamber having essentially a rectangular base area into which the liquid to be analyzed may be placed. Fourth chamber 5 has on two opposite sides a wall formed at least partially by glass plates 12. These glass plates are made of a clear flat glass and have a thickness between 0.5 mm and 2 mm, in particular between 0.7 mm and 1.2 mm in the exemplary embodiment depicted here. As shown in FIG. 3, plastic body 6 has recesses 13, forming a measurement window in the area of glass plates 12. The interior of fourth chamber 5 may be observed through these glass plates 12. Due to the arrangement having two glass plates situated on opposite sides, the measurement chamber may be examined in transmitted light for measurements. An optical quality that permits a high analytical quality is easily achieved by using glass plates 12. Nevertheless, the cost may be minimized so that reagent carriers 1 of the present type are suitable for disposable use. As an alternative, instead of glass plates, plastic plates and/or a plastic insert may be provided. However, they do not usually have the same good optical properties as glass.

Glass plates 12, preferably rectangular or square, are each held in receptacles 14 which are designed in or on fourth chamber 5. In the embodiment shown here, glass plates 12 are situated on the inside of the wall of fourth chamber 5, so they each cover recesses 13 forming the measurement window. The glass plates are not inserted into recess 13 but instead are situated next to it in receptacle 14, as shown here, and have larger dimensions than recess 13. For better sealing and/or holding of the glass plates, receptacles 14 have lips 15 holding glass plates 12 in position and sealing them. Lips 15 extend inward from side walls 16. Lips 15 are designed with a bulge and extend over some or all of the height of fourth chamber 5 along the edge of glass plates 12. Lips 15 may be designed in one piece with the plastic body, as shown here. They also have a prestress, so that glass plates 12 are held in position without play and in particular are pressed against the inside wall of fourth chamber 5.

Fourth chamber 5 is initially empty, and is filled with a sample only during analysis, as explained in greater detail below.

Reagent carrier 1 has a total of four side faces 17, 18, 19, 20. Shorter side face 19 has a different shape than opposing side face 20, thus preventing incorrect insertion into the analyzer. Side face 19 has a concave shape. Side face 20, however, has a convex shape developing into side faces 17 and 18 by way of rounded surfaces.

First, third and fourth chambers 2, 4, 5 are sealed by a first cover film 21, the position of which is indicated with dashed lines in FIG. 1. Second chamber 3, however, is sealed by a second cover film 22, the position of which is also indicated with dashed lines in the figure. First and second cover films 21, 22 made of plastic are welded to reagent carrier 1.

When the reagent carrier is inserted into the analyzer, first cover film 21 remains on the reagent carrier. This film is then punctured by the analyzer to fill the chambers and/or remove fluid from them. Second film 22, however, is removed before inserting the carrier into the analyzer to be able to add blood or another liquid that is to be tested. Therefore, second cover film 22 has a grip section 23 by which the second cover film may be gripped and pulled away.

Reagent carrier 1 according to the present invention has a machine-readable code (not shown here), e.g., in the form of a barcode or pixel code. The code contains information about the reagent contained in the reagent carrier and/or the dye contained therein and/or the size parameters of the measurement chamber. This information may be used to correct the measurement results in the analysis. This is true in particular of the size parameters of the measurement chamber. Differences in thickness of glass plates 12 used or tolerances in the manufacture of plastic body 6 may result in deviations in width B of measurement chamber 5. Such a deviation may influence the measurement accuracy. The measurement results may be corrected automatically by the analyzer because width B of measurement chamber 5 is measured and the particular value and/or a correction factor calculated therefrom is applied to the reagent carrier in a machine-readable form.

The analysis on the basis of reagent carrier 1 according to the present invention is performed as follows: First, second cover film 22 is removed and a small quantity of the fluid to be tested (e.g., blood) is introduced into second chamber 3. After adding the blood, reagent carrier 1 is inserted into the analyzer. A partial amount of blood is then conveyed by the analyzer out of second chamber 3 and into third chamber 4, where it is mixed with dye to permit subsequent measurement in a flow-through measurement system, for example. In addition, another partial amount of blood is conveyed by the analyzer from second chamber 3 into fourth chamber 5, where it is brought in contact with a quantity of reagent contained in first chamber 2 before the measurement is performed in fourth chamber 5.

As part of the analysis, one or more mixing steps may be performed, moving reagent carrier 1 back and forth. Protrusions and/or webs 9, 11 improve the mixing in second and third chambers 3, 4.

The reagent carrier according to the present invention is intended for a single use. Accordingly, the substances present in first and/or third chambers 2, 4 are each measured out as single doses for a single measurement.

What is claimed is:

1. A reagent carrier comprising:
a reagent chamber containing a reagent;
a fluid chamber configured to hold a body fluid;
a dye chamber configured to hold a dye; and
a measurement chamber.

2. The reagent carrier as recited in claim 1, wherein the body fluid includes blood.

3. The reagent carrier as recited in claim 1, wherein the reagent induces hemolysis.

4. The reagent carrier as recited in claim 1, wherein the dye chamber holds a dye excitable to fluorescence by red light and having an absorbance maximum in the range between 610 nm and 650 nm.

5. The reagent carrier as recited in claim 4, wherein the dye is oxazine-1 perchlorate.

6. The reagent carrier as recited in claim 4, wherein the dye is in a solution containing a buffer to regulate the pH in particular.

7. The reagent carrier as recited in claim 1, further comprising a machine-readable code.

8. The reagent carrier as recited in claim 7, wherein the code contains information about at least one of the reagent, dye, and a size parameter of the measurement chamber.

9. The reagent carrier as recited in claim 1, further comprising a first cover film sealing the reagent chamber, the dye chamber, and the measurement chamber.

10. The reagent carrier as recited in claim 9, further comprising a second cover film sealing the reagent chamber.

11. The reagent carrier as recited in claim 10, wherein the second film has a grip section configured for use in a pulling of at least a portion the second film away from the reagent chamber.

12. The reagent carrier as recited in claim 10, wherein a body of the reagent carrier defining the reagent chamber, the fluid chamber, the dye chamber and the measurement chamber is made of plastic, and wherein at least one of the first and the second cover film is welded to the body.

13. The reagent carrier as recited in claim 1, wherein a volume of the second chamber is less than a volume of the first chamber.

14. The reagent carrier as recited in claim 1, wherein at least one of the reagent chamber, the fluid chamber and the dye chamber have side walls that are inclined in at least some sections.

15. The reagent carrier as recited in claim 1, a volume of the fluid chamber is between 50 and 150 microliters and a volume of each of the reagent chamber, dye chamber and measurement chambers is between 250 and 350 microliters.

16. The reagent carrier as recited in claim 1, wherein at least one of the fluid chamber and the dye chamber includes at least one of protrusions and webs.

17. The reagent carrier as recited in claim, wherein the fluid chamber contains an anticoagulant.

18. The reagent carrier as recited in claim 17, wherein the anticoagulant is in the form of a lyophilizate.

19. The reagent carrier as recited in claims 1, further comprising a glass plate on at least one side of the measurement chamber.

20. The reagent carrier as recited in claim 19, further comprising at least one receptacle and wherein the at least one glass plate is disposed in the at least one receptacle.

21. The reagent carrier as recited in claim 20, wherein the at least one receptacle has lips, the lips at least one of holding and sealing the at least one glass plate.

22. The reagent carrier as recited in claim 19, wherein the reagent chamber, the fluid chamber, the dye chamber and the measurement chamber are defined in a plastic body of the reagent carrier, wherein the glass plate is disposed in the plastic body, and wherein a wall of the plastic body adjacent the glass plate includes a recess.

23. The reagent carrier as recited in claim 22, wherein the recess is covered by the glass plate.

24. The reagent carrier as recited in claim 23, further comprising a receptacle for receiving the glass plate disposed on an inside of a wall of the measurement chamber.

25. The reagent carrier as recited in claim 1, wherein the reagent carrier has two sets of two opposing side faces, at least one side face having a shape differing from a shape of an opposing side face.

26. The reagent carrier as recited in claim 25, wherein one side face has a convex curvature and an opposing side face has a concave shape.

27. A reagent analysis devise, comprising:
a reagent carrier having a reagent chamber containing a reagent, a fluid chamber configured to hold a body fluid, a dye chamber configured to hold a dye, and a measurement chamber; and
a device for determining the parameters of blood introduced into the fluid chamber.
